(19) United States
(12) Patent Application Publication
(10) Pub. No.: US 2008/0118618 A1
(43) Pub. Date: May 22, 2008

(54) Process and an apparatus for moulding frozen edible products

(75) Inventors: Paul Edward Cheney, Sharnbrook (GB); Paul Michael Doehren, Sharnbrook (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Conopco Inc, d/b/a UNILEVER

(21) Appl. No.: 11/800,138

(22) Filed: May 4, 2007

(30) Foreign Application Priority Data
May 5, 2006 (EP) EP06252400

(51) Int. Cl. A23P 1/10; A23G 3/02

(52) U.S. Cl. 426/515; 249/105

(57) ABSTRACT

Process for moulding a frozen edible product wherein a mould cavity is filled with the frozen edible product through an opening, the surface of the mould cavity being at a temperature in the AFT range or below, the frozen edible product being subsequently released from the mould cavity characterised in that part of the surface of the mould cavity is at a temperature in the AFT range.

### FIELD OF THE INVENTION

The present invention relates to a process and an apparatus for moulding frozen edible products such as ice creams.

### BACKGROUND OF THE INVENTION

It is a well known phenomenon that when a food product is put onto a frozen substrate, it sticks to it and any attempt to release it from its support leads to structural damage and some food remaining stuck on the support.

Over the last twenty years has been recognised the physical phenomenon of Zero Adhesion Temperature. One of the first patent applications describing it is WO90/06693 which discloses that when a food product such as fish filets is put onto a frozen support, the food product does not stick onto the support if the temperature is cold enough.

Later on, it was suggested that the temperature range which can be used for the freezing and moulding of food products is quite narrow since allegedly too low a temperature would lead to structural damage even though the frozen edible product did not stick to its support. EP582327 and EP827696 disclose such technology.

WO 2004/017748 more recently showed that a very low temperature, far from being detrimental enabled a proper manufacturing and release of moulded frozen articles.

So, all the developments up to now have been towards moving to lower and lower temperatures in order to facilitate the release of the frozen edible product. The main problem of such a trend is that it is very energy demanding.

JP62-91148 attempted to offer a process operating at warmer temperatures and proposed a process for the manufacturing of ice balls while addressing the problem of ice sticking to the walls of the cavities and which can be described as follows. When the corresponding cavities of the pair of rollers pass the point where they are the closest to one another, the frozen product in each cavity is not pressed hard enough against the contiguous product situated into the corresponding cavity on the other roller, when the cavities move again away from each other through the rotation of the rollers, the force linking the two half products is too weak in comparison with the adhesion between each half product and the cavity in which it is and thus it stays in the cavity and does not demould’. JP62-91148 addresses this problem by i) heating one of the roller with an internal circulation of hot liquid, ii) by providing ejection mechanisms in each cavity of the other roller, I and iii) providing excess material proud of the roller surface. These ejection mechanisms allow for the two half products to be pressed together while heating one roller allows for demoulding the product.

It has now been found that it is possible to operate at much warmer temperatures in such a way that, when released from its support, the frozen edible product does not present any structural damage. It has now been found that there is a temperature range wherein a frozen edible product adheres to a frozen support but can be pulled away from this support while keeping its physical integrity and while more particularly not leaving any frozen edible product on the support.

### Tests and Definitions

Zero Adhesion Temperature (ZAT)

Zero Adhesion Temperature is the temperature of a given surface at which a given product put in contact with said surface does not stick. This phenomenon has been known for many years and is for example disclosed in WO90/06693. Further studies have revealed that this temperature is a function of:
the product put in contact with the surface,
the material constituting the surface

So ZAT is not a fixed parameter, it has to be understood and construed as a temperature which is function of the product and of the surface the product is touching. It can be easily determined by experiments.

For ice creams typical values are −60° C. for aluminium supports and −70° C. for stainless steel supports.

Adhesive Failure Temperature (AFT)

It has now been discovered that above ZAT, there are actually two temperature ranges:
a first temperature range, just above ZAT, wherein the product will stick to the support but can be removed from said support using some force, no product being left on the support, and
a second temperature range, warmer than the first temperature range wherein the product will stick to the support and if force is applied to try and remove the product from the support, structural damage will occur, part of the product keeping stuck on the support.

In the course of the following description, the first temperature range is called Adhesive Failure Temperature range (AFT) whereas the second temperature range is called Cohesive Failure Temperature range (CFT).

AFT and CFT are, as ZAT, function of the support and of the product itself but can easily be determined by experiment as follows.

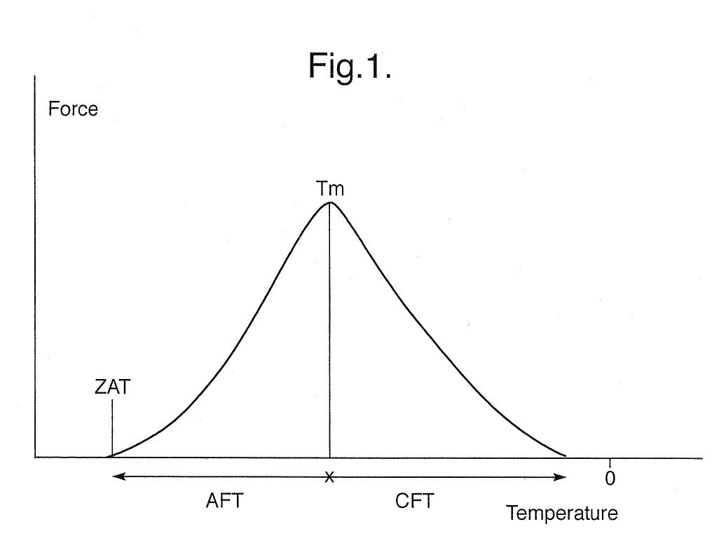

A product of given shape is put into contact with a flat surface of a given material at a given temperature. Then a force is applied against on the product to see the force necessary to free the product away from the flat surface and the force is plotted against the temperature leading to a graph as disclosed on FIG. 1.

What can be seen is that as the temperature gets colder below 0° C., the product starts to stick and it becomes harder and harder to free it until the force necessary to free it reaches a maximum at temperature Tm. Then as the temperature gets colder, the force necessary to free to product away from the support decreases until and when no force is eventually required to free the product, at which point the Zero Adhesion Temperature has been reached. The exact value of the force necessary to free the product at a given temperature depends upon the size and shape of the product sticking to the surface.

What has been discovered is that at temperature between ZAT and Tm, the product can be freed from the surface without suffering from structural damage (i.e. no product is left on the surface) whereas for temperature above Tm (warmer), attempts to free the product away from the surface leads to product being left stuck to the surface. Tm can be a single temperature point or a narrow temperature range.

AFT is the temperature range between ZAT and Tm. CFT is the temperature range above (warmer) Tm.

Ice Cream

Ice creams are defined in “Ice Cream”, Vlth Edition, Kluwer Academic, Plenum Publishers. They may contain inclusions such as fruit bits, chocolate nuggets or sauce.

Overrun

Overrun is defined by the following equation

$$OR = \frac{\begin{matrix}volume . . of . . ice . . cream - \\ volume . . of . . premix . . at . . ambient . . temp\end{matrix}}{volume . . of . . premix . . at . . ambient . . temp} \times 100$$

It is measured at atmospheric pressure.

### BRIEF DESCRIPTION OF THE INVENTION

It is a first object of the invention to provide a process for moulding a frozen edible product wherein a mould cavity is filled with the frozen edible product through an opening, the surface of the mould cavity being at a temperature in the AFT range or below, the frozen edible product being subsequently released from the mould cavity characterised in that part of the surface of the mould cavity is at a temperature in the AFT range.

By having part of the mould cavity at a temperature within the adhesive failure temperature range, it is possible to have a moulded product which will be releasable on demand once ejection means is applied. It prevents the frozen edible product from randomly or immediately falling by gravity from the mould cavity if particularly the mould cavity is facing downward.

Operating, even only partially, at a temperature within the adhesive failure temperature, allows for reducing the energy consumption comparing with the prior art wherein the whole mould cavity had to be at a temperature below the Zero Adhesion Temperature.

Preferably, the frozen edible product is a frozen aerated product, more preferably an ice cream. More preferably, the frozen aerated product is at a temperature of between −4° C. and −14° C. before being filled into the open mould cavity, preferably between −5° C. and −9° C.

Preferably also the opening faces downwards when the frozen edible product is released from said cavity.

This allows for simply releasing the frozen edible product by applying ejection means and allowing the product to fall on a supporting surface beneath the mould cavity without having to use complex lifting and handling mechanisms.

It is a second object of the invention to provide an apparatus for operating the process according to the invention said apparatus comprising:
a carousel having a plurality of open mould cavities
said carrousel being rotatable around a vertical axis,
means for cooling said open mould cavities
means for filling said mould cavity with a frozen edible product
means for ejecting a moulded frozen edible product
   characterised in that open mould cavities face downwards.

The carousel rotation can be stepwise or continuous. Preferably, the carousel is rotatable so as to index each open mould cavity to filling positions and ejecting positions.

Filling means comprises a nozzle for injecting frozen edible product into an open mould cavity from beneath the carousel.

Preferably, each open mould cavity has an individually actuating filling means more preferably comprising a piston system capable of delivering the exact required volume into the mould cavity.

Ejecting means is preferably located at the surface of an open mould cavity. It more preferably comprises a rod or a pin moving away from the surface of the open mould cavity.

Cooling means comprise means for placing a freezing surface of a mould cavity in direct or indirect contact with a cryogenic medium.

### DETAILED DESCRIPTION OF THE INVENTION

The present invention will be further described with reference to the drawings wherein;

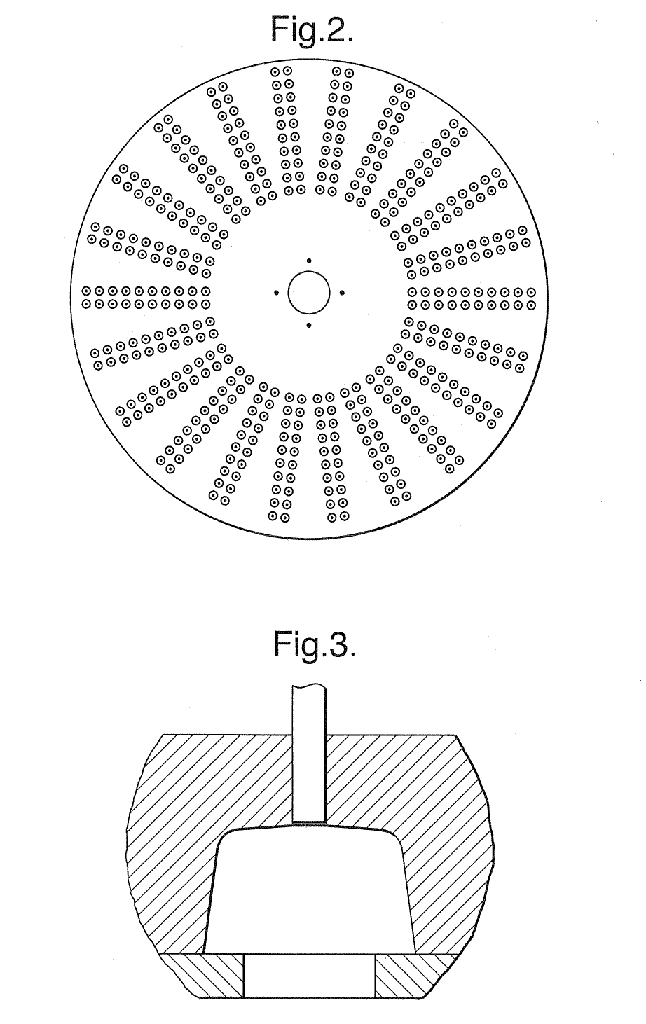

FIG. 2 represents a bottom view of a carousel according to the invention,

FIG. 3 represents a detailed view of the filling of a mould cavity

As can be seen on FIG. 2, a carrousel according to the invention comprises a circular plate 1, presenting open mould cavities 2.

As can be seen on FIG. 3, representing a detailed vertical cross section of a mould cavity, each mould cavity opened at its bottom presents an ejecting means 3 in the form of a sliding rod activated by means not represented.

On FIG. 3 is also represented a part of the filling nozzle 4 which is used to fill the moulded cavity 3 with ice cream. In a preferred embodiment, a single filling nozzle is used to fill a whole group of mould cavities, the filling is then assisted by the use of a piston per cavity to avoid preferential filling of certain cavities.

The surface of open mould cavities 2 is maintained at the required temperature by using a cryogenic coolant circuit not represented. In a preferred embodiment, the nozzle is equipped with a temperature regulation means in order to prevent the nozzle from freezing when in contact with the circulated plate 1.

In operation, the rotating carousel makes an open mould cavity 2 facing the filling nozzle 4. Ice cream is allowed to flow from the nozzle into the cavity until and when the cavity is full at which point, the carousel continuing its rotation, the open cavity is no longer facing the filling nozzle.

Because of the temperature of the surface of the cavity, the ice cream stays within the cavity, adhering to it. When, because of the rotation of the carousel, the open mould cavity filled with ice cream is above a conveyor belt, ejecting means 3 are activating leading to the mould ice cream product to fall on the conveyor belt.

1. Process for moulding a frozen edible product wherein a mould cavity is filled with the frozen edible product through an opening, the surface of the mould cavity being at a temperature in the AFT range or below, the frozen edible product being subsequently released from the mould cavity characterized in that part of the surface of the mould cavity is at a temperature in the AFT range.

2. Process according to claim 1 wherein the frozen edible product is a frozen aerated product, more preferably an ice cream.

3. Process according to claim 1 wherein the opening faces downwards when the frozen edible product is released from said cavity.

4. Apparatus for operating the process according to the invention said apparatus comprising:
a carousel having a plurality of open mould cavities
said carousel being rotatable around a vertical axis,
means for cooling said open mould cavities
means for filling said mould cavity with a frozen edible product
means for ejecting a moulded frozen edible product
characterized in that open mould cavities face downwards.
